(19) United States
(12) Patent Application Publication
(10) Pub. No.: US 2004/0104943 A1
(43) Pub. Date: Jun. 3, 2004

(54) Input of information using a plurality of screens in combination with display of keys with colors, display of information and system using them

(75) Inventors: Shouta Kamasaki, Kawasaki (JP); Takashi Toyokawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/722,186

(22) Filed: Nov. 26, 2003

(30) Foreign Application Priority Data
Nov. 28, 2002 (JP) 2002-346387

(51) Int. Cl. G09G 5/00

(52) U.S. Cl. 345/773

(57) ABSTRACT

The invention relates to a touch-panel keyboard for displaying information of many items of articles and selecting the information, thereby enhancing the searchability of the information. The touch-panel keyboard is used for input processing of information relative to a computer and comprises a display part and a display control part. The display part displays a plurality of keys on each screen. The display control part sets a first screen and a second screen on the display part, displays a plurality of sort keys having different color and one or plurality of first keys, which are displayed with the same colors as those of the sort keys corresponding to the sort keys, on the first screen, switches the first screen to the second screen by operating the sort keys, and displaying the first key or keys, which are similarly displayed on the first screen, while changing the color or colors of the first key or keys with different colors, and second keys displayed with the same colors as those of the sort keys corresponding to the sort keys, on the second screen.

### BACKGROUND OF THE INVENTION

1. Field of the Invention

The invention relates to an information input device suitably adapted for a POS (Point of Sales) system and so forth, particularly to a touch-panel keyboard and a POS system respectively capable of displaying a plurality of keys using a plurality of screens in combination with display of keys and colors, a display method of the touch-panel keyboard, a display program of the touch-panel keyboard and storage medium of the display program of the touch-panel keyboard.

2. Description of Related Art

A POS system has become conventionally widespread in department stores or convenience stores and so forth for selling many items of articles. According to the POS system, a keyboard device is indispensable for registering articles which are to be purchased by customers. The keyboard device arranges a touch panel on a display screen of a liquid crystal display wherein article names are represented on keys displayed on the display screen, and the selected article is registered upon touching on each key.

Meanwhile, there are patent references, for example, JP-A 10-63955, JP-A 2000-339550, JP-A 2001-283324, each disclosing a touch-panel keyboard comprising a plurality of keys arranged on a touch panel wherein a desired article is selected and registered and so forth by operating each key.

JP-A 10-63955 discloses the technique or invention comprising a touch panel on which a plurality of keys are arranged and displays for displaying information such as item of articles and so forth at the positions corresponding to the keys, wherein the item of articles and so forth are selected upon touching on any key with a finger. JP-A 2000-339550 discloses the technique comprising an operation panel structured by arranging a touch panel on a liquid crystal display, wherein keys representing individual articles and keys representing a group of articles are arranged and they are switchable therebetween for every unit of group, thereby reducing the number of keys on the screen. Further, JP-A 2001-283324 discloses sales data registration device which displays keys corresponding to articles and is colored with different colors for every sorting or classification of articles.

Meanwhile, according to the touch-panel keyboard, the number of keys capable of displaying information on one display screen is limited, and the number of item of articles to be dealt is differentiated for every store, and hence if the number of item of articles is large, the size of each key to be displayed on the screen is reduced to cope therewith or a plurality of switchable screens are provided to cope therewith. If the size of each key to be displayed on the screens is reduced, characters such as article names represented on each key is made small to deteriorate searchability of information and operability of keys. Further, in the case of setting the display of keys at a recommended standard size and displaying keys corresponding to item of articles, which are low in frequency of dealing, on a next screen, the operability of each key is not deteriorated, but it is necessary to switch a main screen to a next screen after confirming that the articles to be registered are not present in the main screen, and further, the articles are searched by moving a view point from the previous screen to the next screen, thereby also deteriorating searchability of information.

The above mentioned patent references JP-A 10-63955, JP-A 2000-339550, JP-A 2001-283324 cannot resolve the problem of display of information of many items of articles without changing the size of each key and without deteriorating operability and searchability.

### SUMMARY OF THE INVENTION

The invention relates to a touch-panel keyboard for use in displaying and selecting information such as many items of articles and so forth, and intends to enhance seachablity of information.

Structures of a touch-panel keyboard, a POS system, a display method of the touch-panel keyboard, a display program of the touch-panel keyboard and storage medium of the display program of the touch-panel keyboard respectively resolved the foregoing problem are as follows.

To achieve the above object, the touch-panel keyboard of the invention is used for input processing of information relative to a computer and comprises a display part 72 and a display control part (POS processing part 4). The display part 72 displays a plurality of keys (100) on each screen. Further, the display control part sets a first screen (main screen 80) and a second screen (next screens 80A to 80F) on the display part, displays a plurality of sort keys (90, 90A to 90F) having different colors, and one or plurality of first keys (K1) displayed with the same colors as those of the sort keys corresponding to the sort keys on the first screen, switching the first screen to the second screen by operating the sort keys, displays the first key or keys, which are similarly displayed on the first screen, while changing the color or colors of the first key or keys with different colors, and second keys (K2) displayed with the same colors as those of the sort keys corresponding to the sort keys, on the second screen.

With such a touch-panel keyboard, each key displayed on the screen of the display part has any size, which is, for example, optimum for displaying characters and can be set to any size capable of performing a touch operation with ease. If detection means for detecting the positions of keys is provided, it can detect a key touched by a finger of an operator, and hence the touched key, namely, positional information representing the position of input key is obtained.

Further, the display control part performs the following processings.

(1) Setting the switchable first and second screens.

(2) Controlling the display of a plurality of sort keys and one or plurality of first keys.

(3) Controlling the coloring of first key or keys with the same colors corresponding to the sort keys.

(4) Controlling the switching of the screens.

(5) Controlling the display of the first and second keys corresponding to the switching of the screens.

More specifically, according to the processing of Item (1), the first and second screens serving as a plurality of switchable screens are set to the screen of the display part. The first and second screens have a relationship such that in the plurality of switchable screens, the first screen is the other screen such as a pre-screen and so forth relative to the second screen, and the second screen is the other screen such as a next screen and so forth relative to the first screen, but they do not limit the number of screens. According to the processing of Item (2), a plurality of sort keys or one or plurality of first keys associated with the sort keys are displayed on each screen, one or plurality of keys of the plurality of keys are sorted relative to and associated with the sort keys. According to the processing of Item (3), a plurality of sort keys are colored with different colors, and one or plurality of first keys which are sorted corresponding to the respective sort keys are colored with the same colors so that the relationship between the sort keys and the first keys to be sorted can be visually discriminated by the same colors. According to the processing of Item (4), the display screen of the display part is switched from the first screen to the second screen upon reception of screen switching input. According to the processing of Item (5), the first keys, which are similarly displayed on the first screen, are displayed on the second screen with colors which are different from that of the first screen, and the second keys displayed corresponding to the sort keys on the second screen is displayed with the same colors as those of the sort keys. Although the contents of the processings are explained while dividing into Items (1) to (5), these processings can be executed at the same time, for example, the processings of Items (1) and (2) can be executed at the same time or processings of Items (3) to (5) can be executed at the same time. Further, the same colors include colors which are different in brightness and saturation. The different colors include colors which are different not only in hue but also in brightness and saturation.

According to such a touch-panel keyboard, a plurality of switchable screens are set, the sort keys having different colors, and one or plurality of first keys which are associated with the sort keys with colors are displayed on each screen, and the screens are switched therebetween by operating the sort keys, and the first key or keys, which are displayed on the first screen, while changing the color or colors of the first key or keys with different colors, are displayed on the second screen, and then the second keys appearing on the second screen are displayed with the same colors as those of the sort keys, thereby associating the second keys with the sort keys with colors so that the number of information selected by a keyboard, for example, information per unit of key can be increased without increasing the number of keys on one screen, and the visibility of the keys with colors, learning property of the positions of keys are improved, and searchability of information can be enhanced without the occurrence of any inconvenience when switching the screens. More specifically, the first and second screens are displayed while associated with one another by the sort keys and the colors, and the number of keys can be increased by switching the first and second screens, while the visibility, learning property and the operability of the keys can be enhanced, and the searchability of information by the keys can be improved without changing the size of each key.

Further, to achieve the above object, the touch-panel keyboard of the invention may be configured to include a display part for displaying a plurality of keys on each screen and having detection means for detecting a position of any of the keys, and a display control part for setting first and second screens on the display part, displaying a plurality of sort keys having different colors and one or plurality of first keys, which are displayed with the same colors as those of the sort keys corresponding to the sort keys, on the first screen, switching the first screen to the second screen based on a detection output of the detection means by operating the sort keys, and displaying second keys, which are displayed with the same colors as those of the sort keys corresponding to the sort keys, on the second screen.

Further, to achieve the above object, the touch-panel keyboard of the invention may be configured to include a display part for displaying a plurality of keys representing individual articles or a group of articles on each screen and having detection means for detecting a position of any of the keys, and a display control part for setting first and second screens on the display part, displaying a plurality of sort keys representing a group of articles having different colors, and first keys, which are provided for every one or plurality of articles sorted to the group of articles, and have the same colors as those of the sort keys, on the first screen, switching the first screen to the second screen based on a detection output of the detection means by operating the sort keys, and displaying one or plurality of second keys representing articles and displayed corresponding to the sort keys on the second screen with the same colors as those of the sort keys.

Still further, to achieve the above object, a POS system of the invention comprises a display part and a display control part. The display part displays a plurality of keys representing individual articles or a group of articles on each screen. The display control part sets first and second screens on the display part, displays a plurality of sort keys representing a group of articles having different colors, and first keys which are provided for every one or plurality of articles sorted to the group of articles, and have the same colors as those of the sort keys, on the first screen, and switching the first screen to the second screen by operating the sort keys, displaying the first key or keys, which are similarly displayed on the first screen, while changing the color or colors of the first key or keys with different colors, and one or plurality of second keys representing articles and displayed with the same colors as those of the sort keys corresponding to the sort keys, on the second screen.

With a plurality of keys representing individual articles or a group of articles on the screen according to the POS system, individual articles or a group of articles represented on each key are selected and registered based on the positions of respective keys which are touched by a finger of an operator. That is, the keys representing the group of specific articles relative to the plurality of keys representing the individual articles are defined as the sort keys.

Accordingly, the display control part in the POS system executes the following processings.

(1) Setting the switchable first and second screens

(2) Controlling the display of a plurality of sort keys representing a group of articles and the first keys representing individual articles.

(3) Controlling the coloring of the sort keys representing the group of articles and one or plurality of first keys representing the individual articles corresponding to the group of articles which are assigned to the sort keys with the same colors.

(4) Controlling the switching of the screens

(5) Controlling the display of the first and second keys corresponding to the switching of the screens.

More specifically, according to the processing of Item (1), the first and second screens serving as a plurality of switchable screens are set to the screen of the display part. The first and second screens merely define the relationship therebetween but do not limit the number thereof. According to the processing of Item (2), a plurality of sort keys representing a group of articles or one or plurality of first keys representing individual articles and associated with the sort keys are displayed on each screen, one or plurality of keys of the plurality of keys are sorted relative to and associated with the sort keys. According to the processing of Item (3), a plurality of sort keys are displayed with different colors, and one or plurality of first keys or keys which are sorted corresponding to the respective sort keys are colored with the same colors so that the relationship between the sort keys and the first key or keys to be sorted can be visually discriminated by the same colors. More specifically, the relationship between the group of articles and articles included in the group of articles is also associated with the same colors, and the group of articles and the articles included in the group of articles are discriminated from the other group of articles and articles included in the other group of articles with different colors. According to the processing of Item (4), the display screen of the display part is switched from the first screen to the second screen upon reception of the screen switching input.

According to the processing of Item (5), the first keys, which are similarly displayed on the first screen, are displayed on the second screen with different colors from the color of the first screen, and the second keys displayed corresponding to the sort keys representing specific group of articles operated on the fist screen on the second screen are displayed with the same colors as those of the sort keys. That is, the first keys representing the articles included in the group of articles assigned to the sort keys are displayed on the first screen with the same colors as those of the sort keys wherein the group of the same articles are colored with the same colors, while the second keys representing the articles of the same group of articles which appear on the second screen are colored with the same colors as the sort keys, so that the presence of the same group of articles on the second screen is informed can be known.

Although the contents of the processings were explained while dividing into Items (1) to (5), these processings can be executed at the same time, for example, the processings of Items (1) and (2) can be executed at the same time or processings of Items (3) to (5) can be executed at the same time.

According to such a POS system, a plurality of switchable screens are set, and the sort keys representing the group of articles with different colors, and one or plurality of first keys representing the articles which are associated with colors are displayed on the screens, while the screens are switched by operating the sort keys, and second keys representing new articles and appearing on the second screen are associated with the sort keys with the same colors as those of the sort keys.

Further, according to the POS system, since the keys, which are associated with each other with colors, are displayed on the plurality of screens without increasing the number of keys so as to cope with many items of articles on one screen, the number of articles per unit of key can be increased without the occurrence of any inconvenience when switching the screens, thereby enhancing searchability of articles to be registered, and also enhancing the efficiency of the registration operation. That is, the visibility of the articles represented on the keys, the learning property and the searchability can be enhanced, for example, the operability of the keys in the POS system is improved, thereby enhancing the efficiency of the registration operation.

Further, to achieve the above object, the POS system of the invention may be structured to comprise a display part for displaying a plurality of keys on each screen and having detection means for detecting a position of any of the keys, and a display control part for setting first and second screens on the display part, displaying a plurality of sort keys having different colors and one or plurality of first keys, which are displayed with the same colors as those of the sort keys corresponding to the sort keys on the first screen, switching the first screen to the second screen based on a detection output of the detection means by operating the sort keys, and displaying second keys, which are displayed corresponding to the sort keys, on the second screen with the same colors as those of the sort keys.

Further, to achieve the above object, the POS system of the invention may be structured to comprise a display part for displaying a plurality of keys representing individual articles or a group of articles on each screen and having detection means for detecting a position of any of the keys, and a display control part for setting first and second screens on the display part, displaying a plurality of sort keys representing a group of articles having different colors, and first keys, which are provided for every one or plurality of articles sorted to the group of articles and have the same colors as those of the sort keys, on the first screen, switching the first screen to the second screen based on a detection output of the detection means by operating the sort keys, and displaying one or plurality of second keys representing the articles displayed with the same colors as those of the sort keys corresponding to the sort keys on the second screen.

Further, to achieve the above object, a display method of a touch-panel keyboard for displaying a plurality of keys on each screen cincludes:

A a step of displaying sort keys and one or plurality of first keys corresponding to the sort keys;

B a step of switching between the first and second screens; and

C a step of coloring the first and second keys corresponding to the switching between the first and second screens.

In step A, the sort keys and one or plurality of first keys corresponding to the sort keys are displayed on the first screen, and one or plurality of first keys corresponding to the sort keys and the sort keys are associated with one another with the same colors. In step B, the first screen is switched to the second screen by operating the sort keys. In step C, the first key or keys corresponding to the sort keys are also displayed on the second screen with the colors different from the color of the first screen, and the second keys appearing on the second screen is displayed with the same colors as those of the sort keys.

According to the display method of the touch-panel keyboard, since it comprises setting a plurality of switchable screens, and displaying sort keys having different colors, and one or plurality of first keys which are associated with the sort keys with colors on the screens, displaying the first keys, which are associated with the sort keys and similarly displayed on the first screen, on the second screen with the different colors, associating the second keys appearing on the second screen with the sort keys with the same colors, the number of information selected on the screens, for example, information per unit of key can be increased without increasing the number of keys on one screen, and there does not occur any inconvenience caused by switching the screens, and the functionality of selecting the keys and searchability of information can be enhanced such as enhancement of efficiency of the registration operation.

Further, to achieve the above object, the display method of the touch-panel keyboard of the invention for displaying a plurality of keys representing individual articles or a group of articles on each screen may be configured to include a step of setting first and second screens, a step of displaying a plurality of sort keys representing a group of articles having different colors, and one or a plurality of first keys, which are provided for every one or a plurality of articles sorted to the group of articles and have the same colors as those of the sort keys, on the first screen, a step of switching the first screen to the second screen by operating the sort keys, and a step of displaying the first key or keys, which are similarly displayed on the first screen, while changing the color or colors of the first key or keys with different colors, and second keys displayed corresponding to the sort keys with the same colors as those of the sort keys, on the second screen.

Further, to achieve the above object, a display program of a touch-panel keyboard of the invention is a display program of a touch-panel keyboard for displaying a plurality of keys on the screen and the display method is described by the program. More specifically, the display program is provided with:

a a function of displaying a plurality of sort keys having different colors and one or plurality of first keys, which are displayed corresponding to the sort keys with the same colors, on the first screen,

b a function of switching the first screen to the second screen by operating the sort keys, and

c a function of displaying the first keys, which are similarly displayed on the first screen, while changing the color or colors of the first key or keys with different colors, and second keys displayed with the same colors as those of the sort keys corresponding to the sort keys, on the second screen,

wherein these functions are executed by an information processing unit.

According to the display program of the touch-panel keyboard, desired information can be selected by operating the first key or keys which are distinguished from each other with colors on the first screen, and in the case of searching information which is not assigned to the first key or keys on the first screen, the first screen is changed to the second screen by operating the corresponding sort keys so that desired information can be selected by operating the corresponding second key on the second screen. Further, since the first keys, which are similarly displayed on the first screen, can be displayed on the second screen with colors different from the color of the first screen, sorting of information can be recognized and selected depending on the same or different colors. That is, since the second keys appearing on the second screen are associated with the sort keys with the same colors, even if the amount of information to be selected is increased, it is not necessary to increase the number of keys on one screen, and hence information selected by a keyboard, for example, information per unit of key can be increased in cooperation with the switching of the screens, so that there does not occur any inconvenience caused by switching the screens while associated with the same colors, and hence the number of information selectable by the keys is increased, and functionality of selecting information and searchability of information can be enhanced.

Further, to achieve the above object, the display program of the touch-panel keyboard of the invention for displaying a plurality of keys representing individual articles or a group of articles on each screen may be structured to comprise a function of setting first and second screens, a function of displaying a plurality of sort keys representing a group of articles having different colors, and one or plurality of first keys, which are provided for every one or plurality of articles sorted to the group of articles and have the same colors as those of the sort keys, on the first screen, a function of switching the first screen to the second screen by operating the sort keys, and a function of displaying the first key or keys, which are similarly displayed on the first screen, while changing the color or colors of the first key or keys with different colors, and second keys displayed with the same colors as those of the sort keys corresponding to the sort keys, on the second screen, wherein these functions are executed by an information processing unit.

Still further, to achieve the above object, storage medium of the invention is storage medium for storing the display program of the invention, namely, storage medium for storing the display program of a touch-panel keyboard for displaying a plurality of keys on each screen, and there are following functions to execute the display program.

a a function of displaying a plurality of sort keys having different colors and one or plurality of first keys, which are displayed with the same colors as the sort keys corresponding to the sort keys, on the first screen,

b a function of switching the first screen to the second screen by operating the sort keys; and

c a function of displaying the first key or keys, which are similarly displayed on the first screen, while changing the color or colors of the first key or keys with different colors, and second keys displayed with the same colors as those of the sort keys corresponding to the sort keys, on the second screen,

wherein these functions are executed by an information processing unit.

According to such a storage medium, the switchable first and second screens are set, as set forth above, and the first and second keys corresponding to information, and sort key or keys for sorting information are respectively displayed on each screen, and the first key or keys which are similarly displayed on the first and second screens are changed in colors by switching screens and then the second keys appearing on the second screen are associated with the sort keys with the same colors so that the functionality of selecting keys of the touch-panel keyboard, and the searchability of information can be enhanced.

Still further, to achieve the above object, storage medium of the invention is storage medium for storing the display program of a touch-panel keyboard for displaying a plurality of keys on each screen may be configured to include a function of setting first and second screens, a function of displaying a plurality of sort keys having different colors, and one or plurality of first keys displayed with the same colors as those of the sort keys corresponding to the sort keys, a function of switching the first screen to the second screen by operating the sort keys, and a function of displaying the first key or keys, which are similarly displayed on the first screen, while changing the color or colors of the first key or keys with different colors, and second keys displayed with the same colors as those of the sort keys corresponding to the sort keys, on the second screen, wherein these functions are executed by an information processing unit.

### BRIEF DESCRIPTION OF THE DRAWINGS

Other objects, features and advantages of the invention will be more cleared with reference to the attached drawings and each embodiment of the invention.

FIG. 1 is a block diagram showing the outline of a POS system according to an embodiment of the invention;

FIG. 2 is a block diagram showing a store server of the POS system;

FIG. 3 is a block diagram showing a POS processing part and a keyboard part;

FIG. 4A is a view showing a database;

FIG. 4B is a view showing a data structure of a screen layout file;

FIG. 5 is a view showing a screen structure of the keyboard part;

FIG. 6 is a view showing keys on a main screen of a display part;

FIG. 7 is a view showing colors of keys on the main screen;

FIG. 8 is a view showing colors of keys on a next screen;

FIG. 9 is a view showing colors of keys on another next screen;

FIG. 10 is a view showing characters represented on keys on the main screen;

FIG. 11 is a view showing characters represented on the keys on the next screen;

FIG. 12 is a view showing characters represented on the keys on another next screen

FIG. 13 is a view showing display of characters and colors on the main screen;

FIG. 14 is a view showing display of characters and colors on the next screen;

FIG. 15 is a view showing display of characters and colors on another next screen;

FIG. 16 is a flow chart showing a main routine of the processings according to the embodiment of the invention;

FIG. 17 is a flow chart showing display control processings of the main screen;

FIG. 18 is a flow chart showing article registration processings;

FIG. 19 is a flow chart showing sorting screen display processings;

FIG. 20 is a view showing switching from the main screen to the next screen;

FIG. 21 is a view showing switching from the main screen on the display part to the next screen;

FIG. 22 is a view showing switching from a main screen on a display part to a next screen according to another embodiment of the invention; and

FIG. 23 is a view showing switching from a main screen on a display part to a next screen according to still another embodiment of the invention.

### DETAILED DESCRIPTION OF THE PREFERRED EMBODIMENTS

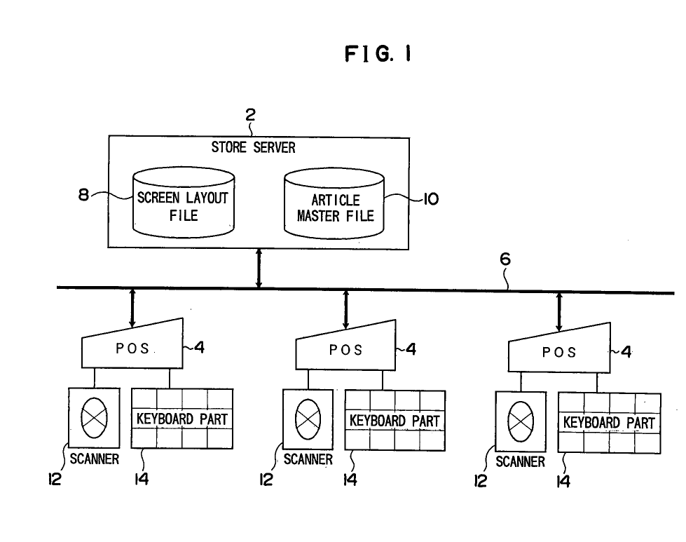

The embodiment of the invention is now described with reference to FIG. 1. FIG. 1 shows the outline of a POS system. A touch-panel keyboard, a display method of the touch-panel keyboard, a display program of the touch-panel keyboard and storage medium of the display program of the touch-panel keyboard according to the embodiment of the invention are embodied in the POS system.

In the POS system, one store server 2 is provided with a plurality of POS processing parts 4 serving as article information processing parts. According to the embodiment, although 3 groups of POS processing parts 4 are installed, these POS processing parts 4 may be installed on a single saleroom or a casher of a store, or individually installed in different stores. One store server 2 and the POS processing part 4 are interconnected with each other via information transmission medium 6 capable of transmitting information such as a LAN (Local Area Network), a cable and so forth. The information transmission medium 6 may be made up of a wireless. The POS processing part 4 may be structured by one group or not less than four groups.

In the POS system, the store server 2 is a computer to structure a database for storing article information or screen information and so forth, and it is divided into a screen layout file 8 serving as screen information and an article master file 10 serving as article information, wherein the screen layout file 8 and the article master file 10 are stored in the store server 2. Further, each POS processing part 4 is structured by a computer and executes processings of information such as article information and so forth which is inputted through a scanner 12 and a keyboard part 14 serving as an input device respectively. The scanner 12 is means for reading out article information such as a barcode from each article to be sold by scanning the barcode and the keyboard part 14 is used for selecting articles by key touch or registering articles.

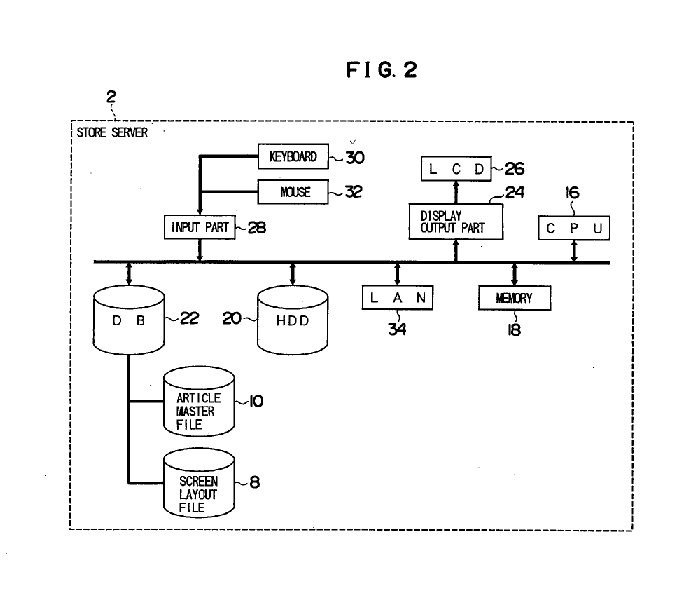

The store server 2 is provided with, for example, as shown in FIG. 2, a CPU (Central Processing Unit) 16 serving as information processing means, a memory 18, a hard disc (HDD) 20 serving as storage means, a database (DB) 22 also serving as storage means, and so forth. The CPU 16 is means for executing various information processings such as creating a database for article information and so forth. The memory 18 is comprised of, for example, a RAM (Random Access Memory), and develops various programs such as a display program which is read out by the CPU 16 from the HDD 20 and so forth, and temporarily holds data and so forth which are under program processing. The DB 22 stores various information and it is provided with the screen layout file 8 and the article master file 10 (FIG. 1) serving as a subordinate database. According to this embodiment, although the DB 22 is structured separately from the HDD 20, the DB 22 may be structured to integrally with the HDD 20.

In the store server 2, a display output part 24 is means for fetching out a display output such as article information and so forth, and display information such as characters, image and so forth which is outputted from the display output part 24 is developed and displayed, for exaple, on an LCD (Liquid Crystal Display) device 26 which is installed as a display part. Further, in the store server 2, an input part 28 is means for fetching various information such as article information and so forth into the CPU 16, and it is provided with a keyboard 30 and a mouse 32 as an input device. The keyboard 30 is means for inputting information such as characters, symbols and so forth to the CPU 16, and the mouse 32 is means for inputting a position on the screen of the LCD device 26. Further, a computer, not shown, serving as other information processing means is connected to the store server 2 via a LAN (Local Area Network) 34.

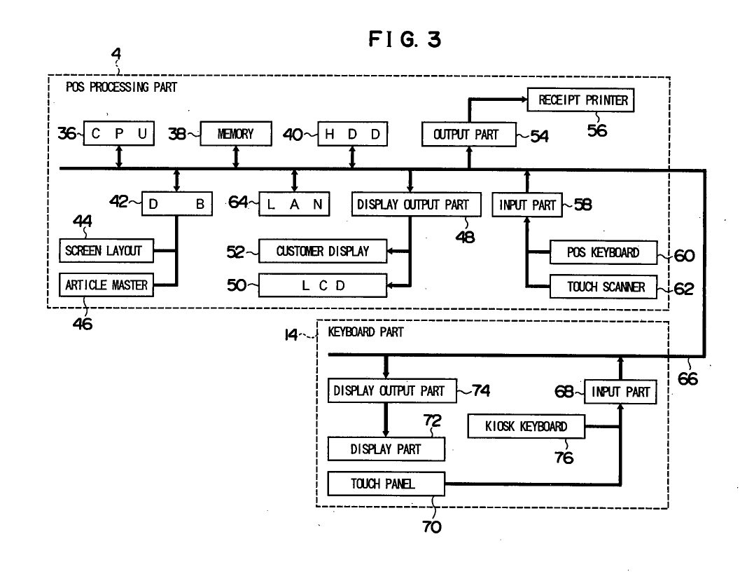

Further, the POS processing part 4 is provided with, for example, as shown in FIG. 3, a CPU 36 serving as information processing means, a memory 38, a HDD (Hard Disc) 40 serving as storage means, a DB (database) 42 serving also as storage means, and so forth. In the POS processing part 4, the CPU 36 is means for executing various information processings such as the display method and the display program of the touch-panel keyboard, and so forth according to the invention. The memory 38 is, for example, comprised of a RAM, and develops various programs such as the display program which are read out by the CPU 36 from the HDD 40 and so forth, and temporarily holds data and so forth which are under program processing. The DB 42 corresponds to the DB 22 of the store server 2 and stores various article information like the DB 22, and it is provided with a screen layout 44 and an article master 46 serving as a subordinate database. According to the embodiment, although the DB 42 is structured separatly from the HDD 40, the DB 42 may be structured integrally with the HDD 40. For storage medium to store the display program and so forth according to the invention, various storage means such as a CD-ROM, an FD, and so forth can be used in addition to the HDD 40.

In the POS processing part 4, a display output part 48 is means for fetching out various display output such as registered articles, other article information and so forth, and display information such as characters, image and so forth outputted from the display output part 48 is, for example, developed and displayed on an LCD device 50, a customer display 52 which are installed as the display part. Further, in the POS processing part 4, an output part 54 is means for outputting, for example, receipt data, and the receipt data is printed on paper by a receipt printer 56 serving as information representing part, and outputted therefrom. Further, an input part 58 is means for fetching various information such as article information and so forth into the CPU 36, and it is provided with a POS keyboard 60, a touch scanner 62 (equal to the scanner 12 in FIG. 1) serving as an input device. The POS keyboard 60 is means for inputting information such as characters, symbols and so forth to the CPU 36, and the touch scanner 62 is means for fetching article information such as an article number, an article name, a price, and so forth into the CPU 36 by reading out article information appearing on the article such as a barcode and so forth. A computer, not shown, serving as other information processing means is connected to the POS processing part 4 via a LAN 64.

Further, the keyboard part 14 is connected to the POS processing part 4 via a cable 66 serving as information transmission medium, wherein the POS processing part 4 functions as a display control part and so forth relative to the keyboard part 14. In the keyboard part 14, an input part 68 is means for fetching article information into the CPU 36, and it is connected to a touch panel 70 serving as an input device, and the touch panel 70 is installed on a display part 72, thereby forming detection means for detecting a position of each key touched by a finger of an operator on the screen which is developed on the display part 72 in response to a display output of the display output part 74. That is, the key touched by the finger of the operator is detected on the touch panel 70 and the touched key, namely, a positional information representing the position of the input key is outputted on the touch panel 70. The display part 72 is, for example, comprised of an LCD device and so forth, and sort keys, one or plurality of keys associated with the sort keys, described later, are displayed on the display part 72 based on the display output from the display output part 74, wherein the position of the touched key is fetched from the input part 68 into the CPU 36 as positional information. In this case, a kiosk keyboard 76 serving as other input means is connected to the input part 68, and it is means for inputting numerical information such as each price of articles and so forth to the CPU 36 via the input part 68 separately from the touch panel 70.

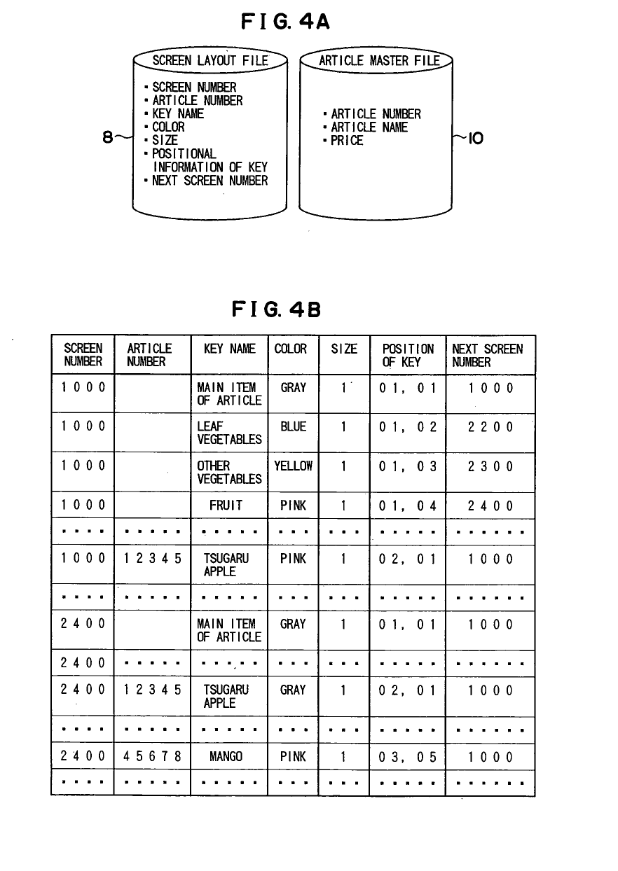

For information stored in the DB 22 of the store server 2, there are screen information relating to screens to be displayed on the display part 72 of the keyboard part 14 such as a screen number, an article number, a key name, a color, a size, positional information of each key, a next screen number and so forth, and also article information such as an article number, an article name, a price and so forth. Whereupon, for example, as shown in FIG. 4A, the screen layout file 8 and the article master file 10 are set in the DB 22, described above, and screen information such as the screen number, the article number, the key name, the color, the size, positional information of each key, the next screen number and so forth are stored in the screen layout file 8 while the article information such as the article number, the article name, the price and so forth are stored in the article master file 10.

If the data structure of the screen layout file 8 is represented by a list, it becomes, for example, as illustrated in FIG. 4B. In this data structure, the screen number is the number showing a main screen serving as a first screen which is set on the display part 72, and it is represented by four digits, for example, represented by “1000” in this embodiment. Further, the article number is the number for discriminating articles to be sold and registered, and it is represented, for example, by five digits. The key name is the name assigned to each of a screen switching key, sorting keys, one or plurality of individual keys associated with the sorting keys respectively displayed on the display part 72, and according to the embodiment, “main item of article”, “leaf vegetables”, “other vegetables”, “fruit”, “Tsugaru apple” and so forth are assigned to each key. In this case, “main item of article” is assigned to the screen switching key, and “leaf vegetables”, “other vegetables”, “fruit” and so forth are assigned to the sorting keys and “Tsugaru apple” and so forth are assigned to the individual keys. The color represents the color assigned to the keys, and according to the embodiment, the sorting keys and one or plurality of individual keys associated with the sorting keys are colored with the same colors. For example, the “fruit” key and “Tsugaru apple” key which are sorted to the fruit are colored with pink. Further, the size represents the shape and size of each key. The positional information of each key represents a position of each key on the screen, for example, the position of “main item of article” key is represented by (01, 01), the position of “fruit” key is represented by (01, 04), and the position of “Tsugaru apple” key is represented by (02, 01). Further, the next screen number represents the next screen serving as the second screen relative to the main screen serving as the first screen, for example, “2400” represents fourth next screen. That is, the second screen is comprised of a plurality of screens.

Further, the article number in the article master file 10 is the same as that in the screen layout file 8, and the article name corresponds to the key name and the price represents the price of individual articles. That is, the screen layout information and the article master information are associated with each other by the article number.

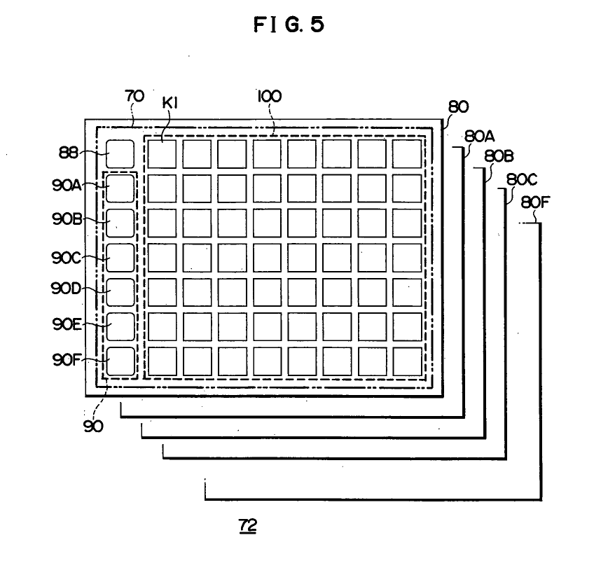

If the display screen is structured by the display method and the display program according to the embodiment of the invention based on this data structure, a main screen 80 serving as the first screen and a plurality of next screens 80A to 80F serving as the second screen are structured in the display part 72 to be switchable therebetween as shown in FIG. 5. A screen switching key 88, a plurality of sort keys 90 corresponding to the sorting of the articles, and keys 100 corresponding to individual articles are displayed on the main screen 80 of the display part 72, wherein the key 100 comprises a plurality first keys, namely, it is structured by first keys K1 which are arranged in M rows and N columns. The key 100 and the keys K1 can be displayed on the next screens 80A to 80F together with the screen switching key 88 and the sort key 90, and one or a plurality of second keys K2 can be displayed only on the next screens 80A to 80F. In this case, in the key 100 to be displayed on the main screen 80 and the next screens 80A to 80F, the keys displayed only on the next screens 80A to 80F are depicted by the keys K2 while the keys similarly displayed on the main screen 80 and the next screens 80A to 80F are depicted by the keys K1.

In the main screen 80, the sort key 90 comprises, for example, a plurality of sort keys 90A to 90F and it is operated upon switching to the next screens 80A to 80F. In this case, the sort keys 90A to 90F have corresponding relationship with the next screens 80A to 80F, for example, the next screen 80A is developed and displayed on the display part 72 by the sort key 90A and the next screen 80B is developed and displayed on the display part 72 by the sort key 90B. In this case, in cases where any of the next screens 80A to 80F serving as the second screens is displayed on the display part 72, it can be returned to the main screen 80 by operating the screen switching key 88 on any of the next screens 80A to 80F. The touch panel 70 installed on the display part 72 detects the positions of the displayed sort keys 90A to 90F and the keys K1, then outputs the operation and positional information of any of the touched sort keys 90A to 90F or keys K1. Meanwhile, in the embodiment, the shapes of the screen switching key 88 and the respective keys K1 associated with the sorting of the sort keys 90A to 90F are square and arranged in matrix, but they are one example, and the invention is not limited to such shapes and arrangement. Further, the positions of the screen switching key 88 and the sort keys 90A to 90F are not necessarily positioned at left side, and they may be positioned at right side or upper/lower side.

If the switchable main screen 80, the next screens 80A to 80F, the screen switching key 88, the sort key 90 and the key 100 are structured in such a manner, the number of display of the key 100 by one screen is limited but the key 100 having the number in proportion to the number of screens can be set by switching the screens using the sort key 90 or the screen switching key 88, and hence a large number of keys can be set without reducing the display size thereof. In this case, although six groups of sort keys 90A to 90F are set, a sort key 90 having not less than six groups may be set. Further, in the case of the next screens 80A to 80F corresponding to the sort keys 90A to 90F, if not less than two next screens 80A₁, 80A₂ . . . are set, for example, in the sort key 90A as one sort key 90, with no one-to-one relationship between the next screens 80A to 80F and the sort keys 90A to 90F, more large number of keys can be set.

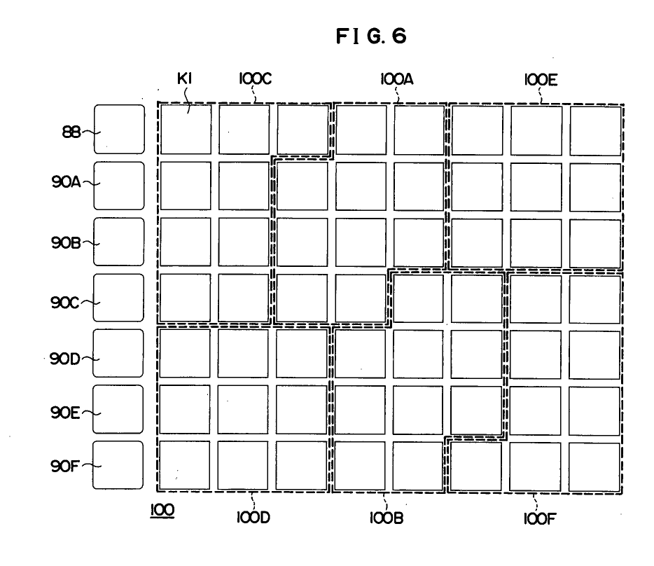

Further, for example, as shown in FIG. 6, key areas 100A to 100F corresponding to the sort keys 90A to 90F are set on the key 100 on the main screen 80, thereby grouping the individual key 100 and the keys K1. In the embodiment, the key areas 100A and 100B corresponding to the sort keys 90A and 90B are positioned at the center of the key 100, the key areas 100C and 100D corresponding to the sort keys 90C and 90D are positioned at the left thereof, and the key areas 100E and 100F corresponding to the sort keys 90E and 90F are positioned at the right thereof. With such an arrangement, for example, it is possible to position any of the sort keys 90A to 90F which is frequently usable at the upper side, and position any of the key areas 100A to 100F at the center thereof depending on the frequency of use.

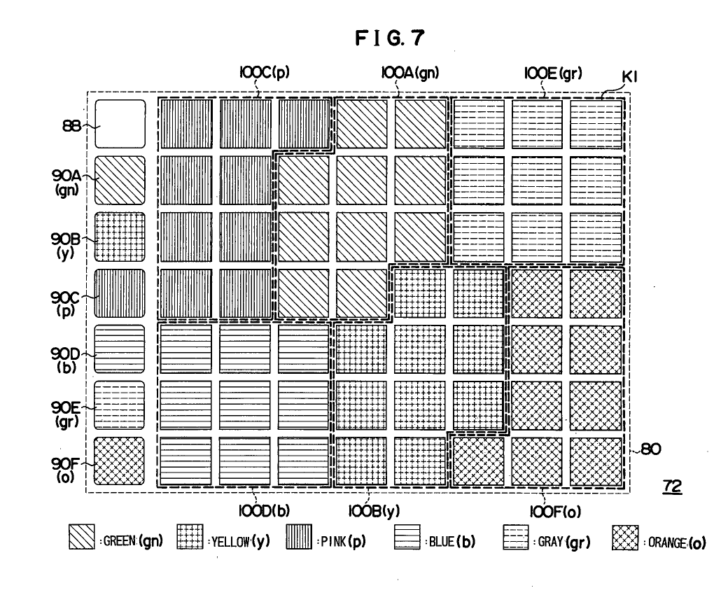

Still further, for example, as shown in FIG. 7, since the sort keys 90A to 90F and the key areas 100A to 100F are colored and displayed on the main screen 80 in the manner that the sort key 90A and the keys K1 included in the key area 100A are colored with the same color, for example, green (gn), the sort key 90B and the keys K1 included in the key area 100B are colored with the same color, for example, yellow (y), the sort key 90C and the keys K1 included in the key area 100C are colored with the same color, for example, pink (p), the sort key 90D and the keys K1 included in the key area 100D are colored with the same color, for example, blue (b), the sort key 90E and the keys K1 included in the key area 100E are colored with the same color, for example, gray (gr), and the sort key 90F and the keys K1 included in the key area 100F are colored with the same color, for example, orange (o), they can be associated with one another with colors. That is, the sort keys 90A to 90F and the key areas 100A to 100F are associated with one another with colors, and the sorting of the key 100 and keys K1 is performed by different colors. With such an arrangement, the relationship between the sort keys 90A to 90F and the plurality of keys K1 can be easily discriminated with colors.

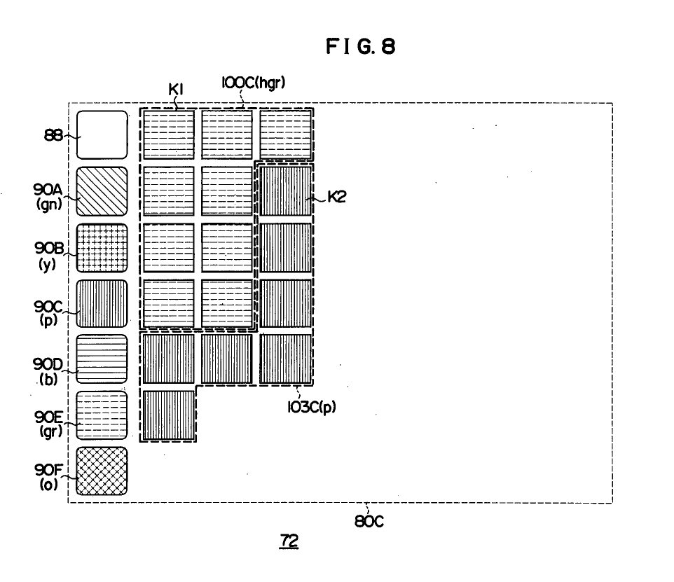

Still further, if the sort key 90C on the main screen 80 is touched by a finger, for example, as shown in FIG. 8, the next screen 80C is developed on the display part 72. The screen switching key 88 and the sort keys 90A to 90F are displayed at the same positions as those of the main screen 80 on the next screen 80C and the keys K1 of the key area 100C are displayed on the next screen 80C, and also the keys K2 of a new key area 103C set on the next screen 80C is also displayed on the next screen 80C. In this case, the keys K1 of the key area 100C are displayed with the different color from that of the main screen 80, for example, displayed with heavy gray (hgr), and the keys K2 of the new key area 103C are displayed with the same color as that of the sort key 90C, in this case, displayed with pink (p). That is, the keys K2 of the new key area 103C and the sort key 90C are associated with each other by the color. Further, the keys of the key areas 10A, 100B, 100D to 100F associated with the other sort keys 90A, 90B, 90D to 90F and displayed on the main screen 80 are erased.

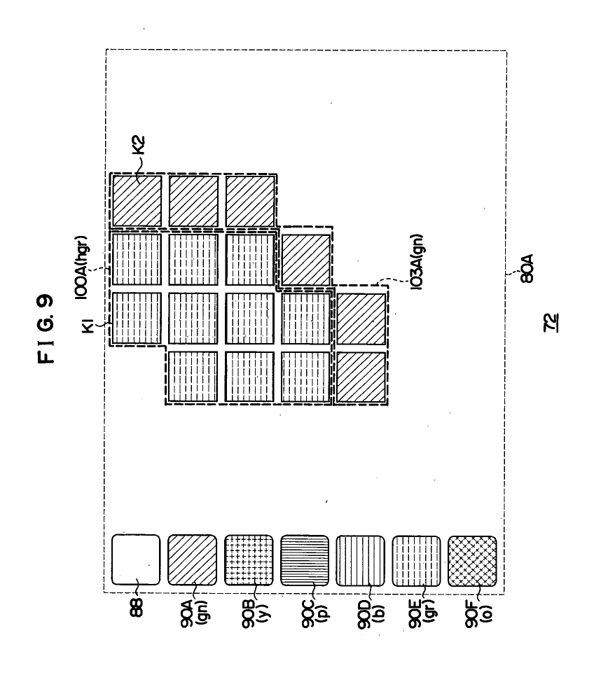

Further, if the sort key 90A on the main screen 80 is touched by a finger, for example, as shown in FIG. 9, the next screen 80A is developed on the display part 72. Likewise, the screen switching key 88, the sort keys 90A to 90F, and the keys K1 of the key area 100A are displayed at the same positions as those on the main screen 80 on the next screen 80A and the keys K2 of a new key area 103A are also displayed on the next screen 80A. In this case, the keys K1 of the key area 100A are displayed with the different color from that of the main screen 80, for example, with heavy gray (hgr), and the keys K2 of the new key area 103A are displayed with the same color as that of the sort key 90A, in this case with green (gn). Likewise, the keys K2 of the new key area 103A and the sort key 90A are associated with each other with the color, and the keys K1 of the key areas 100B to 100F associated with the other sort keys 90B to 90F displayed on the main screen 80 are erased.

In such a manner, the screens can be switched by operating the sort keys 90A to 90F, and the keys K1 of the key areas 100A to 100F displayed on the next screens 80A to 80F corresponding to the sort keys 90A to 90F are displayed with the different colors from that displayed on the main screen 80 while the keys K2 of the new key areas 103A to 103F which newly appear on the next screens 80A to 80F are associated with the sort keys 90A to 90F with the same colors and displayed, while the keys belonging to other key areas erased, thereby enhancing discriminating property and searchability of each key. The keys K1 of the new key areas 100A to 100F of the main screen 80 to be displayed on the next screens 80A to 80F corresponding to the sort keys 90A to 90F are colored with quite colors, for example, with gray, so that the keys K1 can be easily discriminated from the keys K2 of the new key areas 103A to 103F appearing on the next screens 80A to 80F.

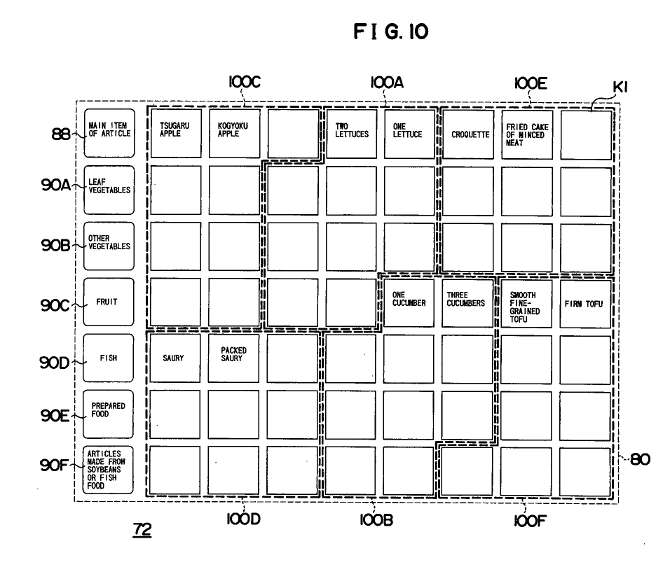

Further, the main item of article, the names representing each group of articles (sorting of articles), individual article names, as shown in FIG. 4B, are represented on the screen switching key 88, the sort keys 90A to 90F, and the keys K1 of the key areas 100A to 100F on the main screen 80 using, for example, characters shown in FIG. 10. In this case, “main item of article” is assigned to the screen switching key 88, “leaf vegetables” is assigned to the sort key 90A and “other vegetables” and so forth are assigned to the sort key 90B. Accordingly, “two lettuces”, “one lettuce” and so forth are assigned to the keys K1 of the key area 100A to which, for example, “leaf vegetables” is assigned while “Tsugaru apple”, “Kogyoku apple”, and so forth are assigned to the keys K1 of the key area 100C to which “fruit” is assigned.

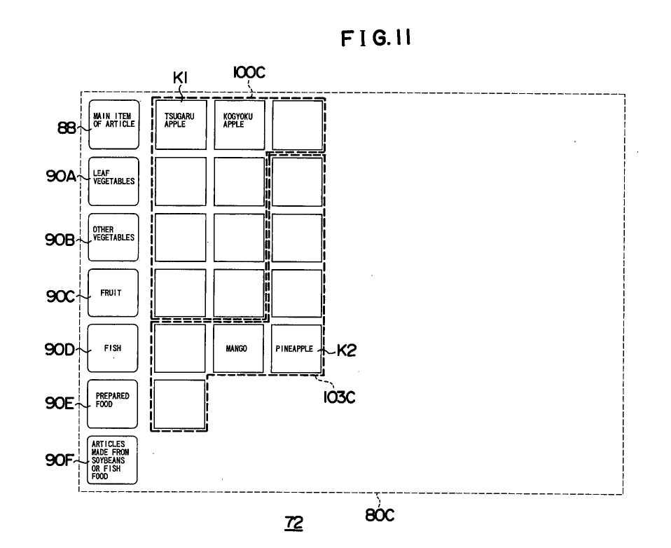

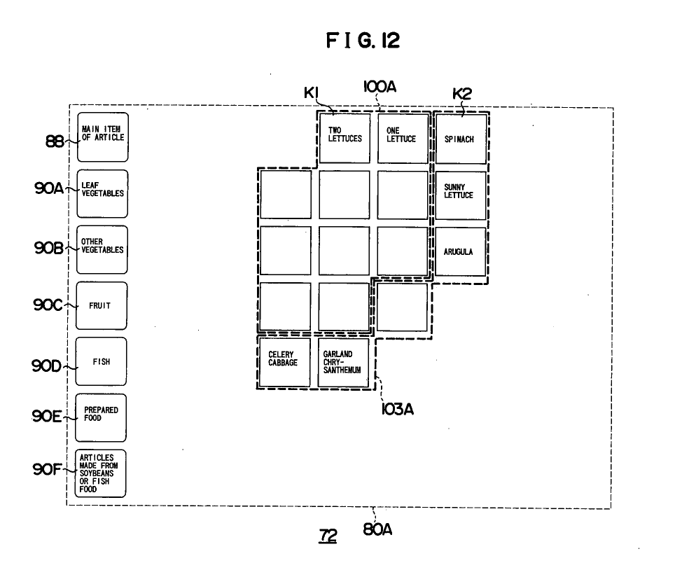

In the next screens 80A to 80F which is developed by operating the sort keys 90A to 90F, “Tsugaru apple”, “Kogyoku apple” and so forth represented on the keys K1 of the key area 100C, which are similarly displayed on the main screen 80, for example, as shown in FIG. 11, are displayed on the next screen 80C, and also “mango”, “pineapple” and so forth associated with the sort key 90C are represented on the key K2 of the new key area 103C. Further, “two lettuces”, “one lettuce” and so forth are represented on the keys K1 of the key area 10A, which are similarly displayed on the main screen 80, for example, as shown in FIG. 12, and also “spinach” “sunny lettuce”, “arugula”, “celery cabbage”, “garland chrysanthemum” and so forth associated with the sort key 90A are represented on the keys K2 of the new key area 103A.

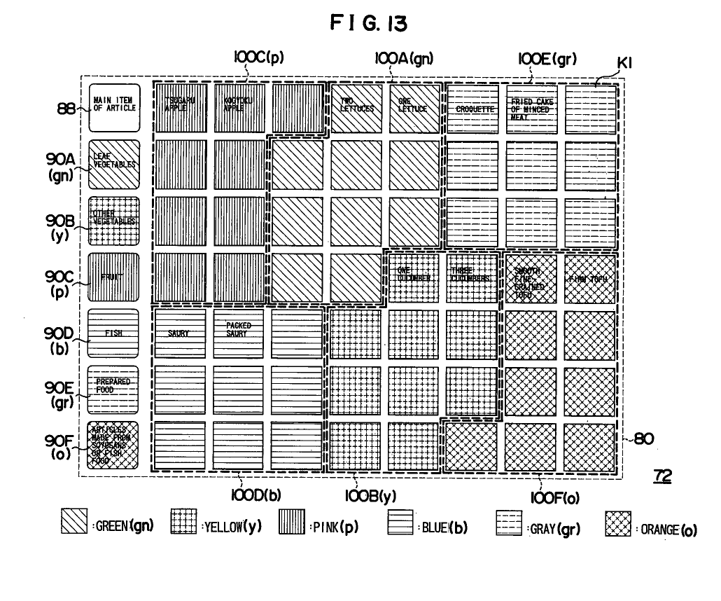

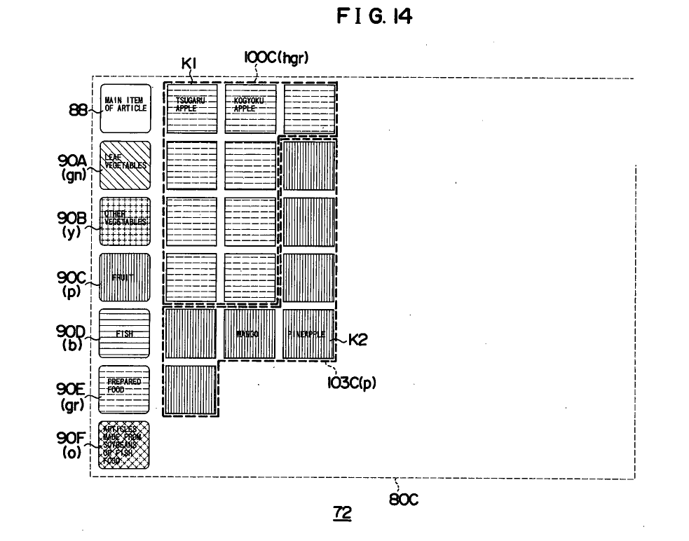

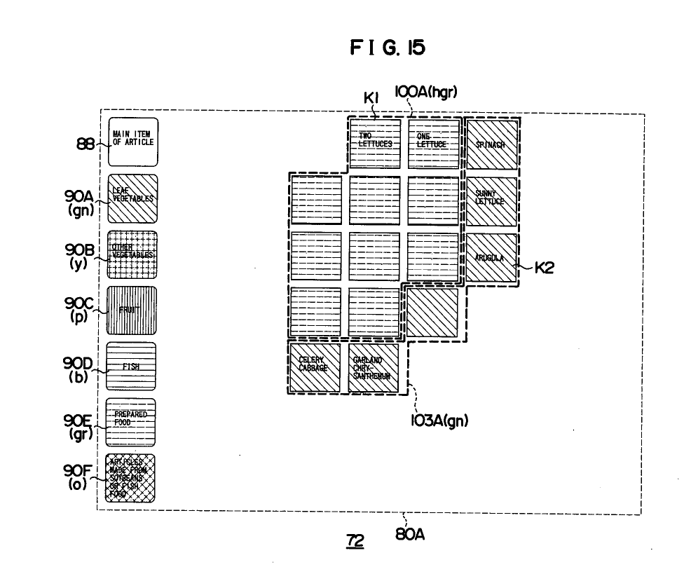

If the colors and the characters as set forth above are represented, while overlapping with each other, on the sort keys 90A to 90F of the main screen 80 and the next screens 80A to 80F, and the keys K1, K2 of the key areas 100A to 100F which are respectively developed on the display part 72, the main screen 80 is displayed, for example, as shown in FIG. 13, the next screen 80C is displayed, for example, as shown in FIG. 14, and the next screen 80A is displayed, for example, as shown in FIG. 15.

In such a display method, since each group of articles sorted by the sort keys 90A to 90F can be discriminated by characters and colors, and article names included in each group of articles can be individually represented on each key K1 while associated with the sort keys 90A to 90F with the same colors, each key 100 and each key K1 associated with the sort keys 90A to 90F can be easily discriminated therebetween, so that the visibility of the keys K1, K2 associated with the sort keys 90A to 90F with colors can be enhanced, and searchability of each article to be registered can be enhanced.

Further, in this case, since the same articles represented on the keys K1, which are arranged at the common position on the main screen 80, are displayed even on the next screens 80A to 80F, and new articles represented on the keys K2 which are set adjacent to the keys K1 to be displayed are also displayed on the next screens 80A to 80F, so that new articles can be selected and registered on the next screens 80A to 80F, and also the articles on the side of the main screen 80 can be selected and registered. Further, if the screen switching key 88 on which “main item of article” is represented is operated, the next screens 80A to 80F can be switched to the main screen 80.

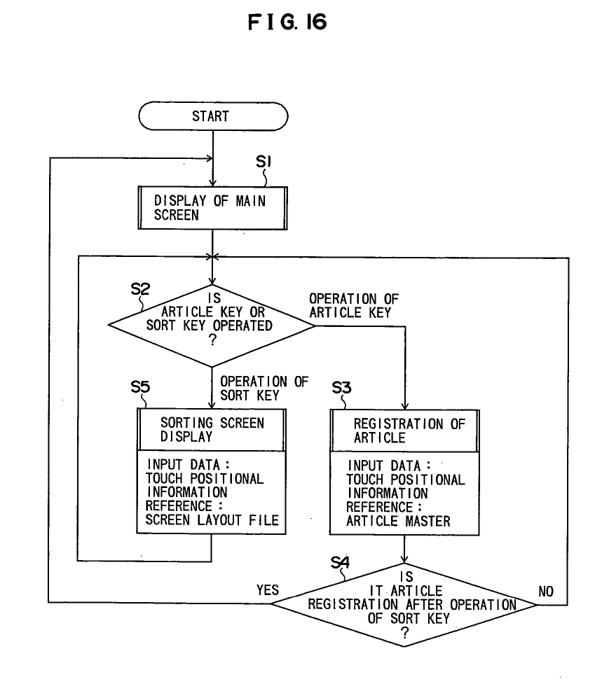

Accordingly, the display method and the display program of the screens using the keyboard part 14 in the POS system of the embodiment of the invention are described with reference to, for example, each flowchart shown in FIGS. 16 to 19.

FIG. 16 shows a main routine of a screen display control. In the main routine, in step S1, the display processing of the main screen 80 is executed. More specifically, as described with reference to FIGS. 5 to 15, the main screen 80 and the next screens 80A to 80F are set on the display part 72, wherein the screen switching key 88, the sort keys 90A to 90F, and the keys K1 of the key areas 100A to 100F are respectively displayed on the main screen 80 and the next screens 80A to 80F with colors, then “main item of article” is assigned or represented on the screen switching key 88, and names representing a group of articles are assigned to the sort keys 90A to 90F, and names of the individual articles are assigned or represented on each key K1, and the main screen 80 displaying these keys representing article names is displayed.

In step S2, it is discriminated whether the keys K1 on which the names of individual articles are represented, namely, the article keys are operated, and any of the sort keys 90A to 90F is operated. If the article key is touched by a finger, the article represented on the touched key K1 is selected, and the program goes to step S3 where the article registration processing is executed. In the article registration processing, a touch positional information of the touched key K1 is outputted from the touch panel 70, thereby referring to the article master file 10 based on the positional information so that the article number, the article name and the price are read out and registered.

After step S3, in step S4, it is decided whether the article registration is completed or not after the operation of the sort keys 90A to 90F, and if the article registration is not completed after the operation of the sort keys 90A to 90F, the program returns to step S2.

Further, in the case where any of the sort keys 90A to 90F is operated in step S2, the program goes to step S5 where the display processing of the next screens 80A to 80F, which are associated with the sort keys 90A to 90F as the sorting screen display processing, is executed. In this case, a touch positional information of any of the touched sort keys 90A to 90F is outputted from the touch panel 70, thereby referring to the screen layout file 8 based on the positional information so that any of the next screens 80A to 80F associated with the touched sort keys 90A to 90F is developed on the display part 72, and also the keys K2 of new key areas 103A to 103F together with any of the key K1 of the key areas 100A to 100F corresponding to the sort keys 90A to 90F are displayed on any of the next screens 80A to 80F.

After such a display, the program returns to step S2, after the selection of article key and the registration processing of the article are executed in step S3, the program returns to step S1 in the case where the processing after the operation of the sort keys 90A to 90F in step S4 is completed, and the program returns to the display processing of the main screen 80.

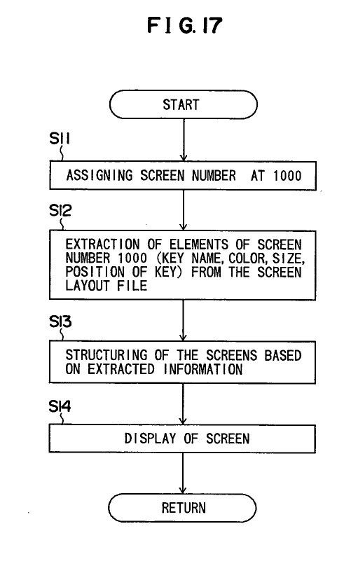

Further, in this program processing, the display processing of the main screen 80 in step S1 is executed, for example, in accordance with the flow chart shown in FIG. 17. FIG. 17 shows display control processings of the main screen 80.

In step S1, the screen number representing the main screen 80, namely, “1000” (screen number shown in FIG. 4B) is set.

If the screen number is set, the program goes to step S12 where elements of screen number “1000”, i.e. information such as the key name, the color, the size, the position of the key and so forth are extracted from the screen layout file 8.

In step S13, the main screen 80 is structured based on the extracted information in step S12, and it is developed and displayed on the display part 72 in step S14. After the main screen 80 is displayed on the display part 72, the program returns to the main routine (FIG. 16).

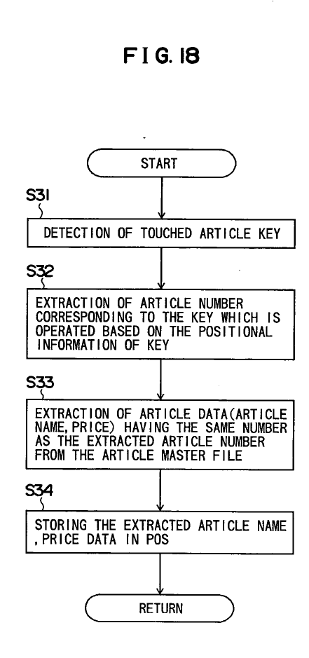

In the program processings shown in FIG. 16, the article registration processing in step S3 is executed, for example, in accordance with the flowchart shown in FIG. 18. FIG. 18 shows article registration processings.

In step S31, the position of the key K2 or key K1 on the main screen 80 or next screens 80A to 80F, which is touched by a finger of an operator, is detected. The detection processing is executed by the touch panel 70, and key positional information representing the position of the touched key is fetched from the touch panel 70 into the CPU 36.

In step S32, the article number corresponding to the key is extracted based on the positional information of the key. That is, this processing is executed to extract the article number with reference to the screen layout file 8.

In step S33, article data having the same number as the extracted article number in step S32 is extracted from the article master file 10. For article information in this extraction processing, for example, the article name and the price are extracted.

In step S34, the article name and the price extracted in step S33 are stored in storage medium such as the HDD 40 of the POS processing part 4 and so forth, thereby completing the article registration processing, and the program returns to the main routine (FIG. 16).

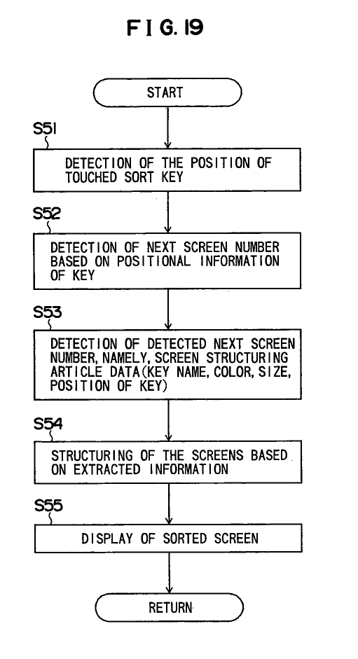

Further, in the program processings in FIG. 16, the sorting screen display processing in step S5 is executed, for example, in accordance with the flowchart shown in FIG. 19. FIG. 19 shows sorting screen display processings.

In step S51, the position of any of the sort keys 90A to 90F on the main screen 80 which is touched by a finger of the operator is detected. This processing is executed by the touch panel 70, and the key positional information representing the position of any of the touched key of the sort keys 90A to 90F is fetched from the touch panel 70 into the CPU 36.

In step S52, the next screen number representing any of the next screens 80A to 80F corresponding to the touched key is detected based on the key positional information of the touched key. That is, this processing is executed with reference to the screen layout file 8.

In step S53, the next screen number extracted in step S52, namely, the key name, the color, the size, the position of the key and so forth forming the screen structure data of the article which becomes the screen number are detected from the screen layout file 8.

In step S54, the next screens 80A to 80F corresponding to the sort keys 90A to 90F are structured based on the screen information extracted in step S53, then the program goes to step S55 where any of the next screens 80A to 80F is developed and displayed on the display part 72. That is, in the case where any of the sort keys 90A to 90F is touched by the finger of the operator to execute the screen switching, thereby the main screen 80 is switched to any of the next screens 80A to 80F, which is in turn displayed on the display part 72.

With such processings, the main screen 80 is displayed on the display part 72, and the sort keys 90A to 90F and the key 100, the keys K1 corresponding to the articles are displayed on the main screen 80, and the next screens 80A to 80F can be displayed by operating the sort keys 90A to 90F, whereby the article can be searched and registered on the main screen 80, and even if the key numbers and the article numbers on the main screen 80 are limited, the main screen 80 is switched to the next screens 80A to 80F associated with the sort keys 90A to 90F and the article can be searched and registered on the next screens 80A to 80F, thereby rendering the display part 72 compact, facilitating the key operation, and enhancing the searchability of the articles using the screen switching in combination with either or both of the representation of characters and the representation of colors.

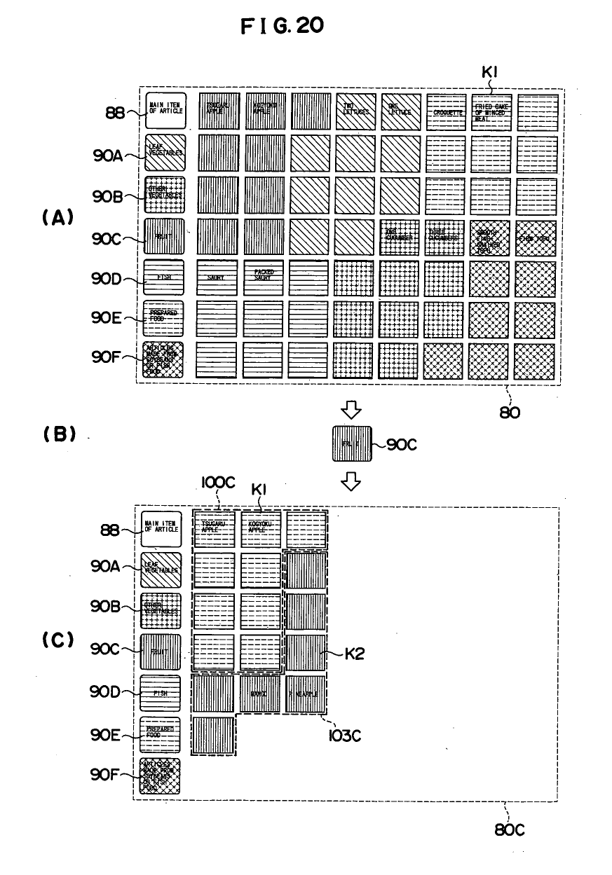

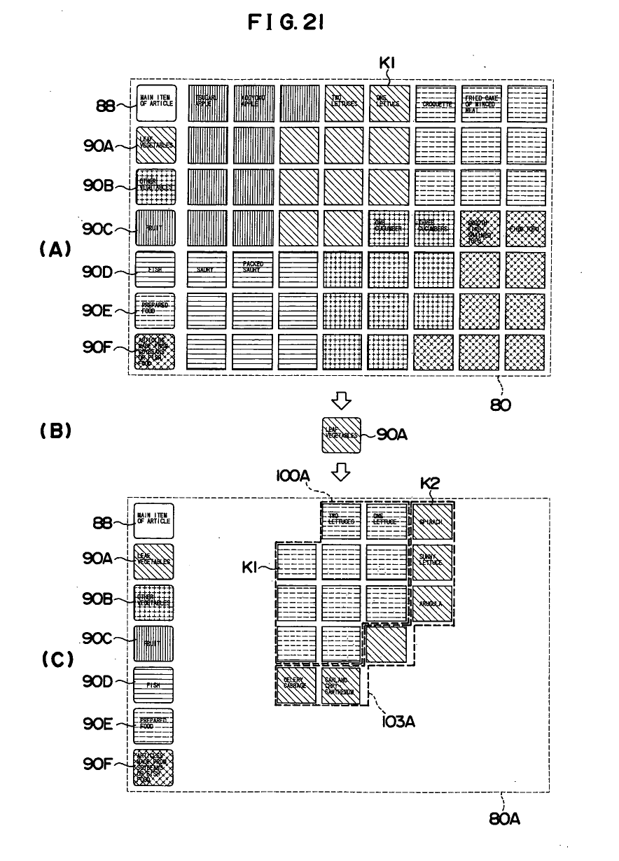

The foregoing processings are explained with reference to FIG. 20 and FIG. 21. FIG. 20 and FIG. 21 show the operation of the registered screen and the switching of the screens.

The main screen 80 is developed and displayed on the display part 72 of the keyboard part 14, for example, as shown in FIG. 20(A). If the key K1 representing “Kogyoku apple” serving as the article registration key is touched on the main screen 80, “Kogyoku apple” is selected and registered. A well-selling line of articles is assigned to the main screen 80, namely, frequently usable article names are displayed on the main screen 80. Accordingly, the articles exceeding the number of keys on the main screen 80 are displayed on the next screens 80A to 80F or unique articles are assigned to the next screens 80A to 80F. For example, in the case where a customer intends to purchase “pineapple”, “pineapple” is not present on the main screen 80. In this case, since “pineapple” is “fruit”, if the sort key 90C representing “fruit” of the sort keys 90A to 90F is touched by a finger, as shown in FIG. 20(B), the next screen 80C is displayed, as shown in FIG. 20(C). In the next screen 80C, the keys K1 belonging to “fruit” displayed on the main screen 80 with pink are displayed with the different color, i.e., gray and so forth, while the new keys K2 appearing on the next screen 80C are displayed with the same color as the sort key 90C, i.e. with pink. Since “pineapple” is present on the next screen 80C, if the key representing the “pineapple” is touched, the article “pineapple” can be registered. If the screen switching key 88 representing “main item of article” is operated upon completion of the article registration on the next screen 80C, the next screen 80C can be switched to the main screen 80.

In the case where the article which is not present on the main screen 80 as shown in FIG. 21(A), for example, “garland chrysanthemum” is selected, the sort key 90A representing “leaf vegetables” is operated as shown in FIG. 21(B), and the next screen 80A is displayed as shown in FIG. 21(C), wherein the key K2 representing “garland chrysanthemum” appearing on the next screen 80A is selected and operated, thereby registering the article “garland chrysanthemum”. Likewise, the next screens 80B, 80D to 80F are displayed by operating the other sort keys 90B, 90D to 90F displayed on the main screen 80, and any of the keys displayed on each of the next screens 80B, 80D to 80F is touched to select the article, thereby registering the article which is not present on the main screen 80.

With such a display method, any of the articles can be selected and registered by switching from the main screen 80 to the next screens 80A to 80F, while the keys K1 of the key areas 100A to 100F associated with the sort keys 90A to 90F are displayed on the next screens 80A to 80F at the same position as those on the main screen 80 with different colors, for example, quiet color such as gray and so forth, so that an operator such as a checker and so forth can expect learning property of the keys at the specific position of each key on the main screen 80. Still further, the keys K2 of the new key areas 103A to 103F representing the articles appearing on the next screens 80A to 80F are displayed adjacent to the key areas 100A to 100F of the main screen 80 so that the leaning property of the keys can be utilized to enhance the searchability.

Further, the frequently usable keys K1 are set on the main screen 80 while the low frequently usable key K2 can be arranged on the next screens 80A to 80F, thereby enhancing the searchability by selecting the keys on the screens.

Further, only the key areas 100A to 100F, new key areas 103A to 103F corresponding to the selected sort keys 90A to 90F are displayed on the next screens 80A to 80F and irelevant keys are erased as shown in FIG. 20(C) and FIG. 21(C), so that the erroneous registration of the articles owing to erroneous operation of the keys can be prevented.

Further, since the main screen 80 can be switched to the next screens 80A to 80F by operating the sort keys 90A to 90F, and the display of the next screens 80A to 80F can be easily switched to return to the main screen 80 by the screen switching key 88 representing “main item of article”, the keys on the main screen 80 and next screens 80A to 80F can be quickly selected, thereby enhancing searchability.

The sort keys 90A to 90F and the keys K1 to be set on the main screen 80 are freely set in respect of the area, the item, the number and the name, while the new key areas 103A to 103F of the next screens 80A to 80F can be freely arranged, and they may be set at the remote positions separately from the key areas 100A to 100F.

According to the embodiment set forth above, although the touch-panel keyboard, the display method of the touch-panel keyboard, the display program of the touch-panel keyboard and storage medium of the display program of the touch-panel keyboard of the invention are described when they are applied to the POS system, the invention is not limited to the POS system.

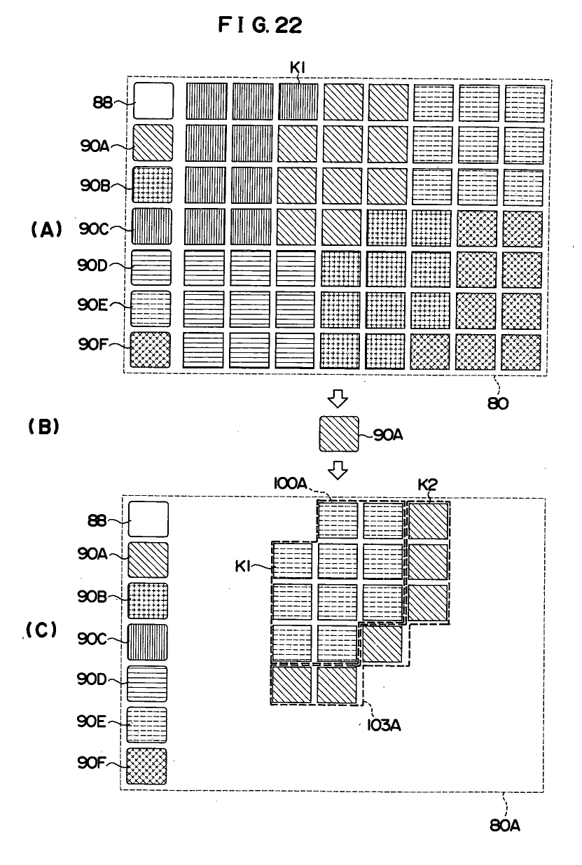

In the case where the keys K1 and keys K2 on the main screen 80 and the next screens 80A to 80F are represented by only the sections or areas and colors except the representation of the group of articles and article names, if, for example, the sort key 90A is operated as shown in FIG. 22(B) on the main screen 80 shown in FIG. 22(A), the keys K1 of the key area 100A associated with the sort key 90A are displayed on the next screen 80A with the different color as shown in FIG. 22(C), so that the keys K2 of the new key area 103A appearing on the next screen 80A can be displayed with the same color as the sort key 90A, thereby selecting and operating the keys K1 and key K2 of the key area 100A and new key area 103A. The input of these keys can be detected by the touch panel 70.

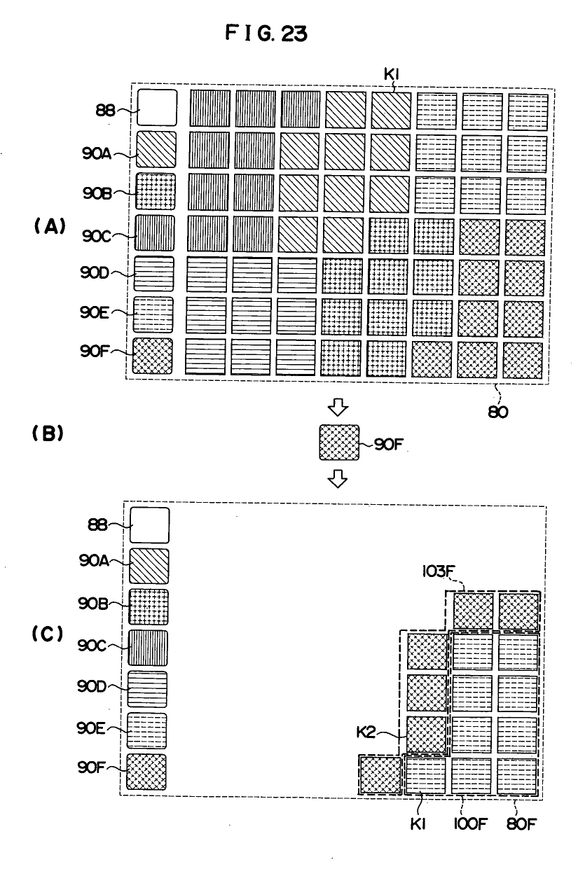

Further, if the sort key 90F is operated as shown in FIG. 23(B) on the main screen 80, for example, as shown in FIG. 23(A), the keys K1 of the key area 100F associated with the sort key 90F are displayed on the next screen 80F with the different color as shown in FIG. 22(C), while the key K2 of the new key area 103F appearing on the next screen 80F can be displayed with the same color as the sort key 90F, so that the keys K1 and keys K2 of the key area 100F and new key area 103F can be selected and operated. Likewise, the positional information of these touched key can be obtained from the touch panel 70.

According to the screen switching, the sort keys 90A to 90F, and one or plurality of keys K1 or K2 associated with the sort keys 90A to 90F, the embodiment can be applied to the various information processings such as selection of articles and selection of information except the registration of articles, and so forth, and the invention is not limited to the registration of articles of the POS system.

For articles and information which are neither displayed on the main screen 80 serving as the first screen nor displayed on any of the next screens 80A to 80F serving as the second screen according to the embodiment, the relationship between the display and the position thereof on each screen can be registered in the store server 2 at any time.

Although the keys K1, which are displayed similarly on the main screen 80, are displayed on the next screens 80A to 80F with different colors from those of the sort keys 90A to 90F according to the embodiment of the invention, the different colors include the colors which are different in brightness, and in the case where the brightness and saturation are differentiated, the keys K1 which are similarly displayed on the main screen 80 and the next screens 80A to 80F can be discriminated, for example, by the shading of the color and so forth. Further, in this case, the keys K2 displayed only on the next screens 80A to 80F are represented with the same colors as those of the sort keys 90A to 90F, the same colors include the colors having different brightness, and it is possible to discriminate whether the keys K2 are displayed on the main screen 80 or the next screens 80A to 80F by the difference in brightness and saturation, for example, by shading of the color.

Although the case where the first keys K1 displayed on the main screen 80 and the first keys K2 displayed on the next screens 80A to 80F are respectively comprised of not less than two keys is described according to the embodiment of the invention, a single key may be provided depending on the key area.

Although the embodiment explained the case where the LCD device unit is used as the display part 72, a light emitting diode may be used to structure the display part 72 or a display unit such as Braun tube and so forth may be used, and the invention is not limited to the LCD device.

As described in detail above, although the invention has been described with reference to the most preferable embodiment, the invention is not limited thereto, and needless to say that various modifications and changes can be made by a person skilled in the art based on the gist of the invention as disclosed in claims, the detailed description of the invention, and such modifications and changes are included in the scope of the invention.

The entire disclosure of Japanese Patent Application No. 2002-346387 including specification, claims, drawings and summary are incorporated herein by reference in its entirety.

What is claimed is:

1. A touch-panel keyboard comprising:
a display part that displays a plurality of keys on each screen; and
a display control part that sets first and second screens on the display part, displaying a plurality of sort keys having different colors and one or plurality of first keys, which are displayed with the same colors as those of the sort keys corresponding to the sort keys, on the first screen, switching the first screen to the second screen by operating the sort keys, and displaying the first key or keys, which are similarly displayed on the first screen, while changing the color or colors of the first key or keys with different colors, and second keys displayed with the same colors as those of the sort keys corresponding to the sort keys, on the second screen.

2. A touch-panel keyboard comprising:
a display part that displays a plurality of keys on each screen and having detection means for detecting a position of any of the keys; and
a display control part that sets first and second screens on the display part, displaying a plurality of sort keys having different colors and one or plurality of first keys, which are displayed with the same colors as those of the sort keys corresponding to the sort keys, on the first screen, switching the first screen to the second screen based on a detection output of the detection means by operating the sort keys, and displaying second keys, which are displayed with the same colors as those of the sort keys corresponding to the sort keys, on the second screen.

3. A touch-panel keyboard comprising:
a display part that displays a plurality of keys representing individual articles or a group of articles on each screen and having detection means for detecting a position of any of the keys; and
a display control part that sets first and second screens on the display part, displaying a plurality of sort keys representing a group of articles having different colors, and one or plurality of first keys, which are provided for every one or plurality of articles sorted to the group of articles and have the same colors as those of the sort keys, on the first screen, switching the first screen to the second screen based on a detection output of the detection means by operating the sort keys, and displaying one or plurality of second keys representing articles and displayed corresponding to the sort keys on the second screen with the same colors as those of the sort keys.

4. A touch-panel keyboard according to claim 1, further comprising a screen switching key provided on the second screen that switches the second screen to the first screen.

5. A touch-panel keyboard according to claim 1, wherein if the first screen is switched to the second screen, the keys of the first keys, which are displayed on the first screen but do not correspond to the sort key that switches the first screen to the second screen, are erased on the second screen.

6. A touch-panel keyboard according to claim 1, wherein if the first screen is switched to the second screen, the first key or keys, which are similarly displayed on the first screen, are displayed on the second screen at position or positions common to that or those on the first screen.

7. A touch-panel keyboard according to claim 1, wherein if the screens are switched by operating the sort keys, the first key or keys, which are similarly displayed on the first screen, are displayed on the second screen with the same color or colors as that or those of the first screen while changing the brightness, and the second keys, which are displayed only on the second screen corresponding to the sort keys, are displayed with the same colors as those of the sort keys.

8. A touch-panel keyboard according to claim 1, wherein key areas of the first key or keys having the same colors are set on the first or second screen, and the second keys having the same colors are disposed adjacent to the key areas of the first key or keys.

9. A touch-panel keyboard according to claim 1, wherein the second keys, which are displayed only on the second screen corresponding to the sort keys, are displayed with the same colors as those of the sort keys while changing the brightness thereof.

10. A POS system comprising:
a display part that displays a plurality of keys representing individual articles or a group of articles on each screen; and
a display control part that sets first and second screens on the display part, displaying a plurality of sort keys representing a group of articles having different colors, and one or plurality of first keys, which are provided for every one or plurality of articles sorted to the group of articles, and have the same colors as those of the sort keys, on the first screen, switching the first screen to the second screen by operating the sort keys, and displaying the first keys, which are similarly displayed on the first screen, while changing the color or colors of the first key or keys with different colors, and one or a plurality of second keys representing the articles displayed with the same colors as those of the sort keys corresponding to the sort keys, on the second screen.

11. A POS system comprising:
a display part that displays a plurality of keys on each screen and having detection means for detecting a position of any of the keys; and
a display control part that sets first and second screens on the display part, displaying a plurality of sort keys having different colors and one or plurality of first keys, which are displayed with the same colors as those of the sort keys corresponding to the sort keys, on the first screen, switching the first screen to the second screen based on a detection output of the detection means by operating the sort keys, and displaying second keys, which are displayed with the same colors as those of the sort keys corresponding to the sort keys, on the second screen.

12. A POS system comprising:
a display part that displays a plurality of keys representing individual articles or a group of articles on each screen and having detection means for detecting a position of any of the keys; and
a display control part that sets first and second screens on the display part, displaying a plurality of sort keys representing a group of articles having different colors, and one or plurality of first keys, which are provided for every one or plurality of articles sorted to the group of articles and have the same colors as those of the sort keys, on the first screen, switching the first screen to the second screen based on a detection output of the detection means by operating the sort keys, and displaying one or plurality of second keys representing the articles displayed with the same colors as those of the sort keys corresponding to the sort keys on the second screen.

13. A display method of a touch-panel keyboard for displaying a plurality of keys on each screen comprising:
a step of setting first and second screens;
a step of displaying a plurality of sort keys having different colors and one or plurality of first keys, which are displayed with the same colors as those of the sort keys corresponding to the sort keys, on the first screen;
a step of switching the first screen to the second screen by operating the sort keys; and
a step of displaying the first key or keys, which are similarly displayed on the first screen, while changing the color or colors of the first key or keys with different colors, and second keys displayed with the same colors as those of the sort keys corresponding to the sort keys, on the second screen.

14. A display method of a touch-panel keyboard for displaying a plurality of keys representing individual articles or a group of articles on each screen comprising:
a step of setting first and second screens;
a step of displaying a plurality of sort keys representing a group of articles having different colors, and one or plurality of first keys, which are provided for every one or plurality of articles sorted to the group of articles and have the same colors as those of the sort keys, on the first screen;
a step of switching the first screen to the second screen by operating the sort keys; and
a step of displaying the first key or keys, which are similarly displayed on the first screen, while changing the color or colors of the first key or keys with different colors, and displaying second keys displayed corresponding to the sort keys with the same colors as those of the sort keys, on the second screen.

15. A display program of a touch-panel keyboard that displays a plurality of keys on each screen comprising:
a function of setting first and second screens;
a function of displaying a plurality of sort keys having different colors and one or plurality of first keys, which are displayed with the same colors as those of the sort keys corresponding to the sort keys, on the first screen;
a function of switching the first screen to the second screen by operating the sort keys; and
a function of displaying the first key or keys, which are similarly displayed on the first screen, while changing the color or colors of the first key or keys with different colors, and second keys displayed with the same colors as those of the sort keys corresponding to the sort keys, on the second screen.
wherein said functions are executed by an information processing unit.

16. A display program of a touch-panel keyboard that displays a plurality of keys representing individual articles or a group of articles on each screen comprising:
a function of setting first and second screens;
a function of displaying a plurality of sort keys representing a group of articles having different colors, and one or plurality of first keys, which are provided for every one or plurality of articles sorted to the group of articles and have the same colors as those of the sort keys, on the first screen;
a function of switching the first screen to the second screen by operating the sort keys; and
a function of displaying the first key or keys, which are similarly displayed on the first screen, while changing the color or colors of the first key or keys with different colors, and second keys displayed with the same colors as those of the sort keys corresponding to the sort keys, on the second screen.
wherein said functions are executed by an information processing unit.

17. Storage medium that stores a display program of a touch-panel keyboard for displaying a plurality of keys on each screen comprising:
a function of displaying a plurality of sort keys having different colors and one or plurality of first keys, which are displayed with the same colors as those of the sort keys corresponding to the sort keys, on a first screen;
a function of switching the first screen to a second screen by operating the sort keys; and
a function of displaying the first key or keys, which are similarly displayed on the first screen, while changing the color or colors of the first key or keys with different colors, and second keys displayed with the same colors as those of the sort keys corresponding to the sort keys, on the second screen.
wherein said functions are executed by an information processing unit.

18. Storage medium that stores a display program of a touch-panel keyboard for displaying a plurality of keys on each screen comprising:
a function of setting first and second screens;
a function of displaying a plurality of sort keys having different colors, and one or plurality of first keys displayed with the same colors as those of the sort keys corresponding to the sort keys, on the first screen;
a function of switching the first screen to the second screen by operating the sort keys; and
a function of displaying the first key or keys, which are similarly displayed on the first screen, while changing the color or colors of the first key or keys with different colors, and second keys displayed with the same colors as those of the sort keys corresponding to the sort keys, on the second screen,
wherein said functions are executed by an information processing unit.
